(19) United States
(12) Patent Application Publication
(10) Pub. No.: US 2007/0113963 A1
(43) Pub. Date: May 24, 2007

(54) Method of making continuous rubber sheet with texture

(76) Inventors: Chung-Hu Hsiao, Taichung City (TW); Den-Yong Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/282,632

(22) Filed: Nov. 21, 2005

(51) Int. Cl. B29C 47/00

(52) U.S. Cl. 156/244.27

(57) ABSTRACT

A method of making a continuous rubber sheet with a texture thereon including the steps of: providing two rollers in front of a nozzle of a device for extruding a rubber material to form a rubber layer on the rollers. Provide a fabric to the rubber layer to form a rubber stack. Provide the rubber stack to a compression rolling set for rolling the rubber stack. Heat the rubber stack for vulcanization, and peel the fabric off.

### BACKGROUND OF THE INVENTION

1. Field of the Invention

The present invention relates generally to a process for making rubber product, and more particularly to a method of making a rubber sheet with texture on a surface thereof.

2. Description of the Related Art

For the present processes of making rubber products, there are some processes making rubber products with a predetermined texture thereon. A typical process is putting the rubber material in a mold before vulcanization. The mold has a cavity with a predetermined shape and texture on a sidewall thereof. The mold and the rubber material are heated for vulcanization. The reason of heating both of the mold and the rubber material at the same time is that the rubber material will deformed in the process of vulcanization when the rubber material is heated alone. The deformed rubber product will have a twisted texture. So the rubber material has to be heated with the mold to make sure the rubber product having a desired texture.

However, such process has some problems. The first problem is the size of mold is limited, so that a bigger rubber product should be made from combining some smaller rubber pieces. Therefore, there is no process to make an integral rubber product of greater size and with texture thereon. The second problem is that the molds are expensive, and the greater size of mold has higher cost. The cheap rubber products can not afford the expensive molds.

### SUMMARY OF THE INVENTION

The primary objective of the present invention is to provide a method of making a continuous rubber sheet with a texture on a surface thereof.

According to the objective of the present invention, a method of making a continuous rubber sheet with a texture thereon includes the steps of: providing two rollers in front of a nozzle of a device for extruding a rubber material to form a rubber layer on the rollers. Provide a fabric to the rubber layer to form a rubber stack. Provide the rubber stack to a compression rolling set for rolling the rubber stack. Heat the rubber stack for vulcanization.

### BRIEF DESCRIPTION OF THE DRAWINGS

FIG. 1 is a sketch diagram of the machine to make the rubber sheet of a first preferred embodiment of the present invention;

FIG. 2 is a sectional view of the rubber sheet of the first preferred embodiment of the present invention;

FIG. 3 is a sketch diagram of the machine to make the rubber sheet of a second preferred embodiment of the present invention;

FIG. 4 is a sectional view of the rubber sheet of the second preferred embodiment of the present invention;

FIG. 5 is a sectional view of the rubber sheet of a third preferred embodiment of the present invention; and

FIG. 6 is a sectional view of the rubber sheet of a fourth preferred embodiment of the present invention.

### DETAILED DESCRIPTION OF THE INVENTION

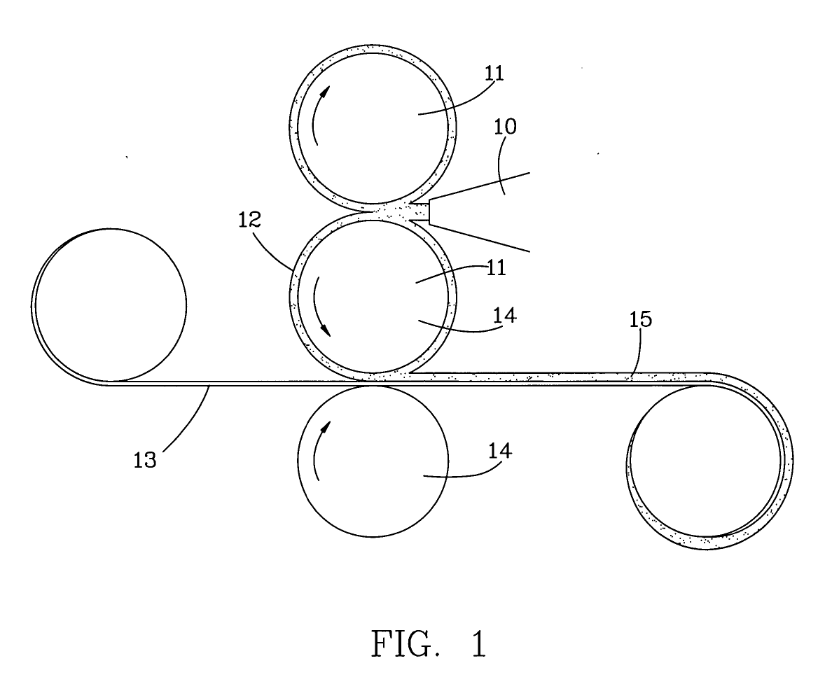

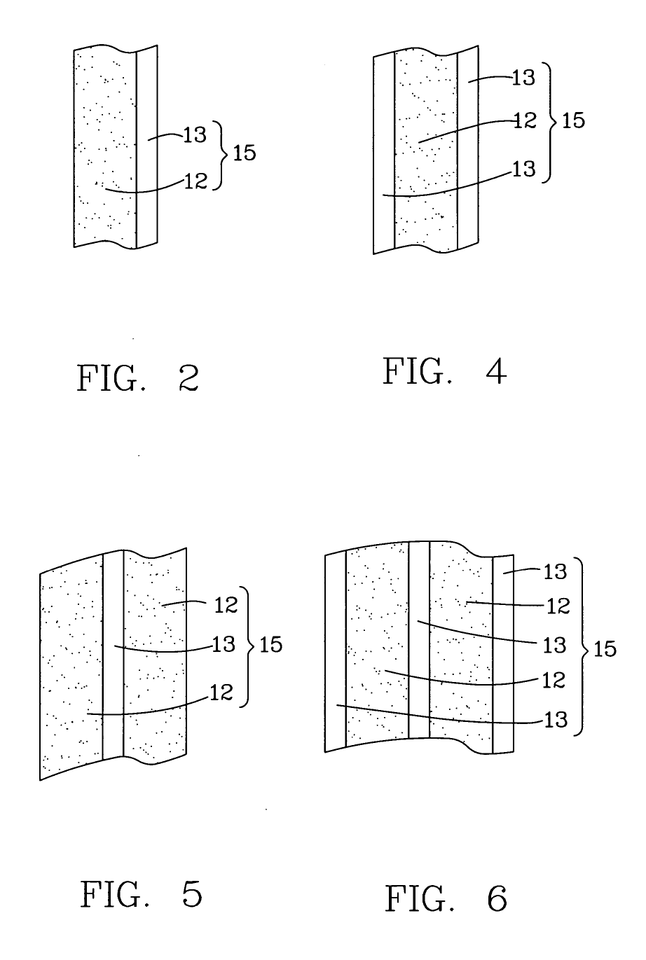

As shown in FIG. 1 and FIG. 2, a method of making a continuous rubber sheet with a texture on a surface thereof of the first preferred embodiment of the present invention comprises the step of:

Provide two rollers 11 in front of a nozzle 10 of a device for extruding a rubber material. The molten rubber material forms a rubber layer 12 on the rollers 11. And then, place a fabric 13 on the rubber layer 12 and pass them through a compression rolling set 14. The fabric 13 is attached on the rubber layer 12 after rolled by the compression rolling set 14 to form a rubber stack 15. And then, heat the rubber stack 15 for vulcanization.

The fabric 13 may be made of cotton, nylon, polymer, or other material, or combination of those. The fabric 13 has a texture inherently that it can serve as a mold to form a texture on the rubber layer. The rubber layer may have the texture on one side or on both sides according to a thickness of the rubber layer. For a thicker rubber layer, when the fabric is peeled, the rubber layer has the texture only on one side where the fabric is attached and has a flat side opposite thereto. On contrary, for a thinner rubber layer, because that the thinner rubber layer will be waved associated with the texture of the fabric when they are rolled, so that there will be textures on both sides of the rubber layer.

The present invention provides the fabric, which has a lower cost and a variety of texture patterns, to serve as the mold for forming the texture on the rubber sheet. As a result, there is no mold used in the process of the present invention. The pattern of the texture can be change by changing the fabric that is a very cheap and easy way to make the rubber sheet with predetermined texture.

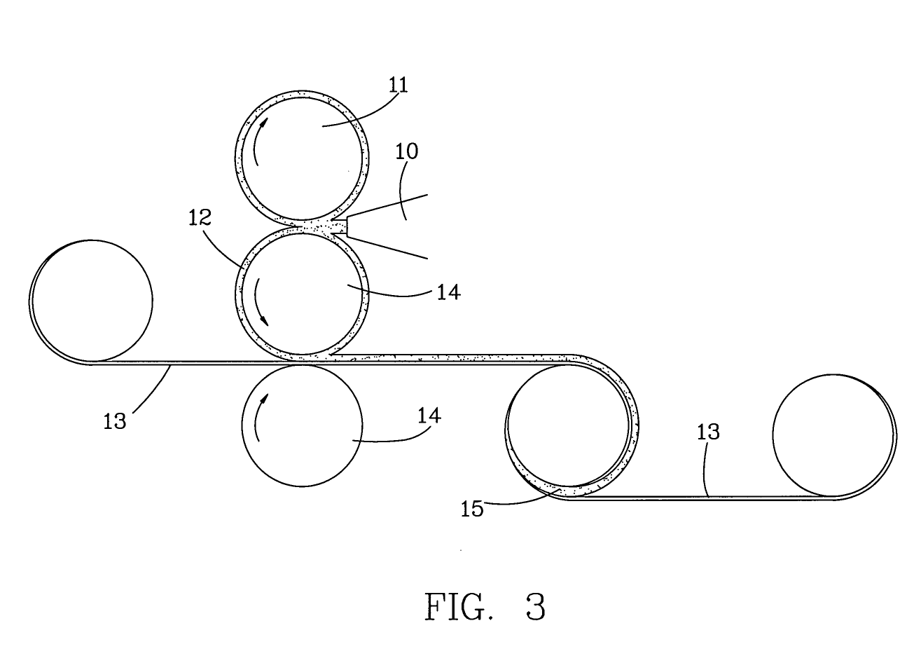

FIG. 3 and FIG. 4 shows the second preferred embodiment of the present invention, which is similar to the first preferred embodiment, except that a rubber layer 12 is attached with two fabrics 13 on both sides thereof. The fabric-rubber-fabric rubber stack 15 is heated for vulcanization.

The second preferred embodiment provides the rubber sheet with textures on both sides. The texture patterns on opposite sides may be different according to the fabrics attached thereon.

As shown in FIG. 5, the third preferred embodiment of the present invention provides a method, which is similar to the methods above, except that there are two rubber layers 12 attached on opposite sides of the fabric 13 to form a rubber-fabric-rubber rubber stack 15, and then the three-layer rubber stack 15 is heated for vulcanization.

The rubber layers 12 have a thinner thickness, such that it will get a rubber sheet with a fabric therein and having textures on both sides.

FIG. 6 shows the fourth preferred embodiment of the present invention, which is similar to the third preferred embodiment, having two rubber layers 12 and three fabrics 13 stacked. The order of the stack is fabric-rubber-fabric-rubber-fabric. So it will get a five-layer rubber stack 15 for vulcanization.

The rubber layers 12 have a thicker thickness, such that it will get a rubber sheet with a fabric therein and having textures on both sides after the exterior fabrics 13 are peeled.

What is claimed is:

1. A method of making a continuous rubber sheet with a texture thereon, comprising the steps of: providing two rollers in front of a nozzle of a device for extruding a rubber material to form a rubber layer on the rollers; providing a fabric to the rubber layer to form a rubber stack; providing the rubber stack to a compression rolling set for rolling the rubber stack; and heating the rubber stack for vulcanization.

2. The method as defined in claim 1, wherein two of the fabrics are attached on both sides of the rubber layer to form the rubber stack with an order of fabric-rubber-fabric.

3. The method as defined in claim 1, wherein two of the rubber layers are attached on both sides of the fabric to form the rubber stack with an order of rubber-fabric-rubber.

4. The method as defined in claim 1, wherein there are two of the rubber layers and three of the fabrics stacked to form the rubber stack with an order of fabric-rubber-fabric-rubber-fabric.

5. A method for a liquid crystal display, wherein the fabric is made of cotton, nylon, or polymer.

6. The method as defined in claim 1, further comprising the step of peeling the fabric off the rubber layer after vulcanization.
